(19) United States
(12) Patent Application Publication
(10) Pub. No.: US 2024/0068485 A1
(43) Pub. Date: Feb. 29, 2024

(54) FAN BLADE

(71) Applicant: PUC Perfect Union Co., Ltd., New Taipei City (TW)

(72) Inventor: Ching Chan, New Taipei City (TW)

(21) Appl. No.: 17/893,257

(22) Filed: Aug. 23, 2022

(51) Int. Cl. F04D 29/38; F04D 19/00

(52) U.S. Cl. CPC F04D 29/388; F04D 19/002

(57) ABSTRACT

A ceiling fan includes a hub and a plurality of blades having an inner end secured to the hub wherein the blade include a hollow body having an internal elongated rib, a curved edge on a first side, a sharp edge on a second side, a curved top surface, and a plurality of transverse grooves on the curved top surface; and an outer end member secured to the hollow body.

### FIELD OF THE INVENTION

The invention relates to blades and more particularly to a ceiling fan incorporating a plurality of blades including a hollow body capable of reducing noise pollution when the ceiling fan operates.

### BACKGROUND OF THE INVENTION

A conventional ceiling fan includes a plurality of blades having a curved top surface. A flow of air is generated when the fan operates. The airflow has a cooling effect.

However, noise is generated when the fan operates because turbulence is generated when the flow of air passes the blade. Conventionally, increasing thickness of the blade and increasing curvature of the blade are used to decrease the turbulence. However, its effect is limited.

Thus, the need for improvement still exists.

### SUMMARY OF THE INVENTION

It is therefore one object of the invention to provide a ceiling fan comprising a hub and a plurality of blades having an inner end secured to the hub wherein the blade include a hollow body having an internal elongated rib, a curved edge on a first side, a sharp edge on a second side, a curved top surface, and a plurality of transverse grooves on the curved top surface; and an outer end member secured to the hollow body.

The above and other objects, features and advantages of the invention will become apparent from the following detailed description taken with the accompanying drawings

### BRIEF DESCRIPTION OF THE DRAWINGS

FIG. 1 is a perspective view of a body of a blade of the invention;

FIG. 2 is a side elevation of the body; and

FIG. 3 is a perspective view of a ceiling fan incorporating the blades.

### DETAILED DESCRIPTION OF THE INVENTION

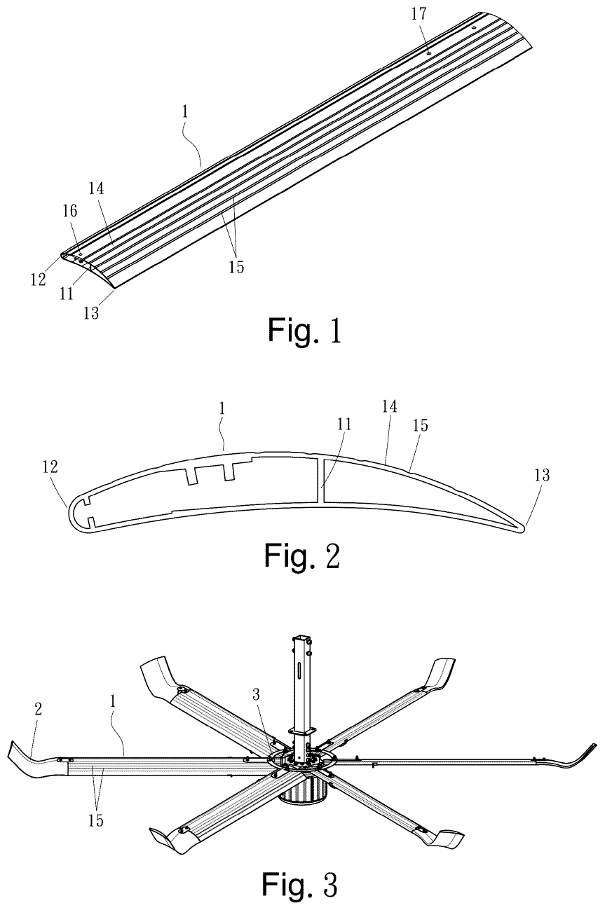

Referring to FIGS. 1 to 2, a hollow body 1 of a blade of the invention comprises an internal elongated rib 11, a curved edge 12 on a first side, a sharp edge 13 on a second side, a curved top surface 14, and a plurality of transverse grooves 15 on the curved top surface 14, a plurality of first holes 16 at one side, and a plurality of second holes 17 at the other side.

Referring to FIG. 3 in conjunction with FIGS. 1 and 2, a ceiling fan comprises a plurality of blades including an outer end member 2 threadedly secured to the hollow body 1 by driving a plurality of screws through the first holes 16 into the outer end member 2, and an inner end threadedly secured to a hub 3 of the ceiling fan by driving a plurality of screws through the second holes 17 into the hub 3 of the ceiling fan.

It is envisaged by the invention that the blades can reduce noise pollution when the ceiling fan operates.

While the invention has been described in terms of preferred embodiments, those skilled in the art will recognize that the invention can be practiced with modifications within the spirit and scope of the appended claims.

1. A ceiling fan comprising a hub and a plurality of blades, each blade having an inner end secured to the hub wherein each blade includes:
a hollow body having a plurality of internal elongated ribs, including a first internal elongated rib extending completely between a first internal surface of the hollow body and a second, opposite internal surface of the hollow body and one or more second internal elongated ribs extending only partially from the first or from the second internal surface of the hollow body,
a curved leading edge,
a sharp trailing edge,
a curved top surface, and
a plurality of transverse grooves on the curved top surface; and an end member secured to the hollow body at an outer end of the blade.
